(19) United States
(12) Patent Application Publication
(10) Pub. No.: US 2008/0004829 A1
(43) Pub. Date: Jan. 3, 2008

(54) METHOD AND APPARATUS FOR AUTOMATIC TEST EQUIPMENT

(76) Inventor: Jacky Gorin, Scottsdale, AZ (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 11/855,030

(22) Filed: Sep. 13, 2007

Related U.S. Application Data
(63) Continuation of application No. 11/300,643, filed on Dec. 13, 2005, now abandoned.
Application No. 11/300,643 is a division of application No. 10/439,070, filed on May 15, 2003, now abandoned.
Application No. 10/439,070 is a continuation of application No. 09/888,104, filed on Jun. 22, 2001, now abandoned.
Application No. 09/888,104 is a continuation-in-part of application No. 09/821,903, filed on Mar. 29, 2001, now abandoned.
(60) Provisional application No. 60/192,834, filed on Mar. 29, 2000.
(60) Provisional application No. 60/213,335, filed on Jun. 22, 2000.
(60) Provisional application No. 60/234,213, filed on Sep. 20, 2000.

(51) Int. Cl. G06F 19/00

(52) U.S. Cl. 702/108

(57) ABSTRACT

Methods and apparatus for automatic test equipment enhance performance of automatic test equipment and provide test engineering tools. Various aspects of the present invention provide improved test times and other performance characteristics for ATE. In addition, a test system according to various aspects of the invention may include test tools to assist personnel in test processes.

### CROSS-REFERENCES TO RELATED APPLICATIONS

This application is: A continuation of U.S. Nonprovisional Patent Application No. 11/300,643, filed Dec. 13, 2005, which: is a divisional of U.S. Nonprovisional Patent Application No. 10/439,070, filed May 15, 2003, which: is a continuation of U.S. Nonprovisional Patent Application No. 09/888,104, filed Jun. 22, 2001, which: is a continuation-in-part of U.S. Nonprovisional Patent Application No. 09/821,903, filed Mar. 29, 2001, which claims the benefit of: U.S. Provisional Patent Application No. 60/192,834 filed Mar. 29, 2000; U.S. Provisional Patent Application No. 60/213,335, filed Jun. 22, 2000; and U.S. Provisional Patent Application No. 60/234,213, filed Sep. 20, 2000; and claims the benefit of U.S. Provisional Patent Application No. 60/213,335, filed Jun. 22, 2000; and claims the benefit of U.S. Provisional Patent Application No. 60/234,213, filed Sep. 20, 2000.

### FIELD OF INVENTION

The invention relates to semiconductor testing, and more particularly, to enhancing performance of automatic test equipment and test engineering tools.

### BACKGROUND OF THE INVENTION

Modern semiconductor products pack powerful functionality into miniscule packages. As semiconductor components become more complex, physical integrated circuits shrink, and manufacturing rates increase, the need for accurate and rapid testing of the circuits sharpens. Although semiconductors testing, especially new products, is crucial to maintain quality control, testing slows the overall productivity of the manufacturing process and adds complexity and cost to an already very complex and expensive process.

Automatic test equipment (ATE) performs most modern testing of semiconductors during the engineering and production processes. The ATE receives a collection of components, often provided on a single wafer, as a batch of packaged integrated chip components, circuit board, or system, and automatically provides input signals to the various components and measures the components' output responses. With the ever-increasing complexity of semiconductors and other electronics products, however, ATE is increasingly complex as well. Accordingly, ATE represents a large investment that requires regular upgrading and replacement as new technology surpasses the capabilities of older ATE.

To maximize the value of an ATE, semiconductor manufacturers strive to improve the efficiency and effectiveness of the ATE while maintaining testing accuracy. Even minor improvements in the test time for each individual circuit tested may incrementally save significant sums by improving the throughput of the ATE, thus reducing the overall cost per component. Further, improvements in the functionality and flexibility of the ATE tends to extend the usefulness of the ATE.

### SUMMARY OF THE INVENTION

Methods and apparatus for automatic test equipment enhance performance of automatic test equipment and provide test engineering tools. Various aspects of the present invention provide improved test times and other performance characteristics for ATE. In addition, a test system according to various aspects of the invention may include test tools to assist personnel in test processes.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 is a block diagram of an exemplary testing system;

FIG. 2 illustrates a process for improving a test program;

FIGS. 3A-B illustrate a test process and a matrix for organizing the test process;

FIGS. 4A-B illustrate an original and a modified test sequence;

FIGS. 5A-B illustrates a process for using characterization data;

FIG. 6 illustrates a wait period refinement process;

FIG. 7 illustrates a process for identifying acceptable components for wait period refinement;

FIG. 8 illustrates a baseline data process;

FIG. 9 illustrates a wait time refinement data process;

FIG. 10 illustrates an optimized wait period confirmation process;

FIG. 11 illustrates a wait time refinement process using converging approximation;

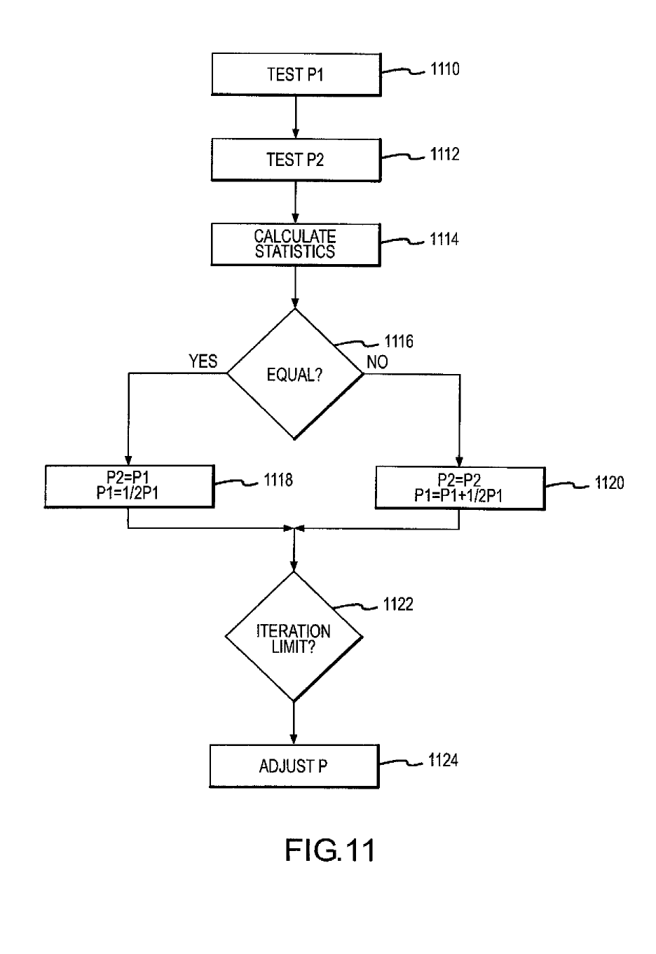

FIG. 12 illustrates a process for calculating guardbands; and

FIG. 13 illustrates a process for testing using sampling.

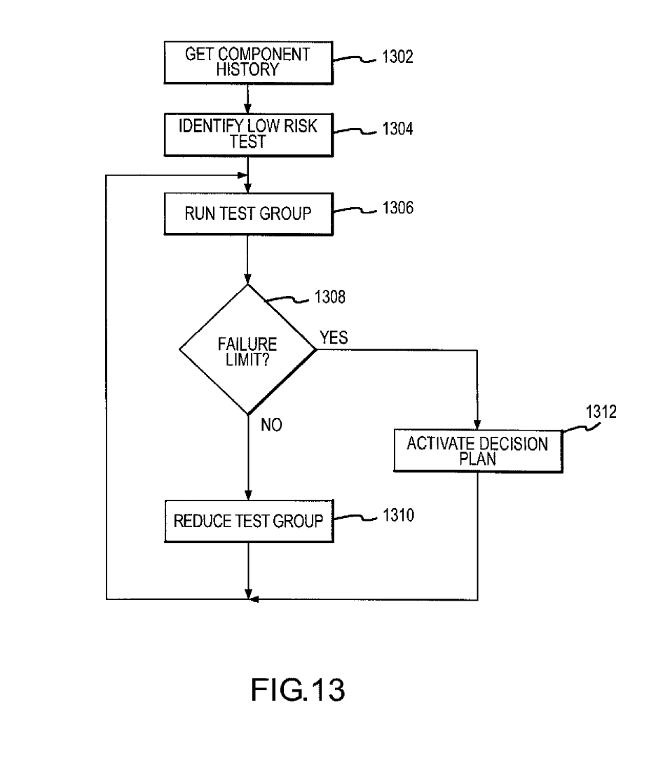

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described herein in terms of functional block components and various processing steps. Such functional blocks may be realized by any number of hardware or software components configured to perform the specified functions and achieve the various results. For example, the present invention may employ various machines, processors, and integrated circuit components, e.g., statistical engines, memory elements, signal processing elements, logic elements, look-up tables, and the like, which may carry out a variety of functions under the control of one or more testers, microprocessors, or other control devices. In addition, the present invention may be practiced in conjunction with any number of statistical processes, and the system described herein is merely one exemplary application for the invention. Further, the present invention may employ any number of conventional techniques for data analysis, component interfacing, data processing, component handling, and the like.

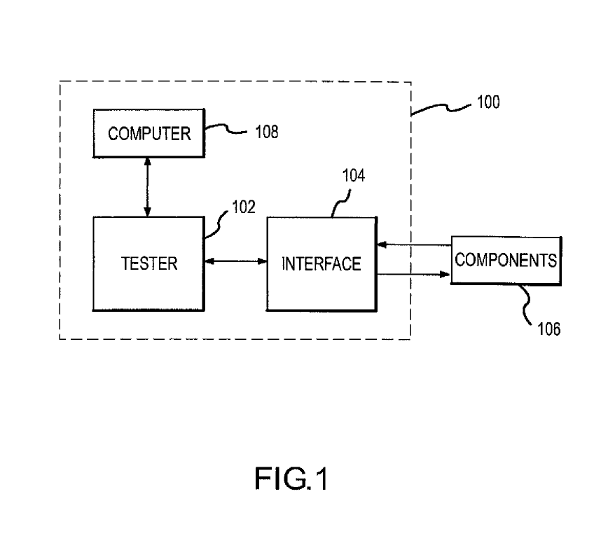

Referring to FIG. 1, a test system 100 for testing components 106 according to various aspects of the present invention operates in conjunction with a tester 102, such as ATE for testing semiconductors. The test system 100 may be configured for testing any components 106, such as semiconductor devices on a wafer, circuit boards, packaged integrated circuit chips, or other electrical or optical systems. In the present embodiment, the components 106 comprise multiple integrated circuit dies formed on a wafer and/or packaged devices. The tester 102 may comprise a conventional automatic tester, such as a Teradyne tester, and suitably operates in conjunction with other equipment for facilitating the testing. For example, the tester 102 may include one or more internal processors, and may operate in conjunction with a separate user computer. The test system 100 may also include a device interface 104, like a conventional device interface board and/or a device handler or prober, to handle the components 106 and provide an interface between the components 106 and the tester 102. In addition, the tester 102 may operate with a separate computer system 108, for example a cell controller computer. The tester 102, the separate computer system 108, and other components may operate independently or cooperate and interact to perform various functions, such as program the tester 102, load and/or execute the test program, collect data, provide instructions to the tester 102, implement a statistical engine, control tester parameters, and perform any other appropriate computing functions, control functions, and the like.

The tester 102 applies test signals to the components 106 via the device interface 104, gathers and analyzes test data, and identifies the quality of the components 106 according to the data. The tester 102 may be programmed to operate independently, or may be controlled by the computer 108. To test a component 106, the tester 102 provides various input test signals to the component 106, waits for a selected wait period, and reads the corresponding output test signals from the component 106. A single component 106 may be subjected to several different kinds of tests, and various tests may be repeated. In addition, the various tests may have different wait periods or more than one wait period associated with the test. The resulting output signals are stored and analyzed to identify potentially defective components 106.

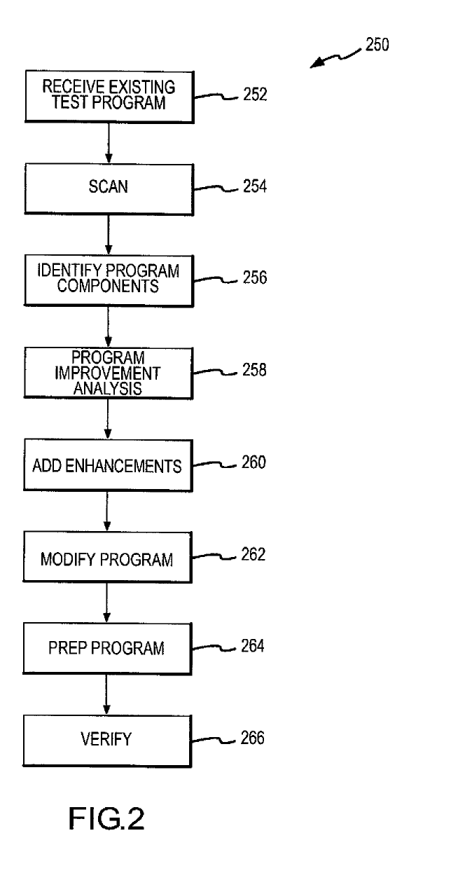

The test system 100 according to various aspects of the present embodiment may be configured to automatically enhance operation, such as by improving the efficiency and effectiveness of the test system 100. Any number of techniques and processes may be implemented in the test system 100 to achieve various results. For example, in one embodiment, the test system 100 is configured to automatically improve an existing test program for operating the test system 100. Referring to FIG. 2, the test system 100 suitably performs a test program enhancement process 250 to improve the test program. In the present embodiment, the test program enhancement process 250 operates on the computer 108, though the process may be performed by any suitable system, such as the tester 102 or a remote server.

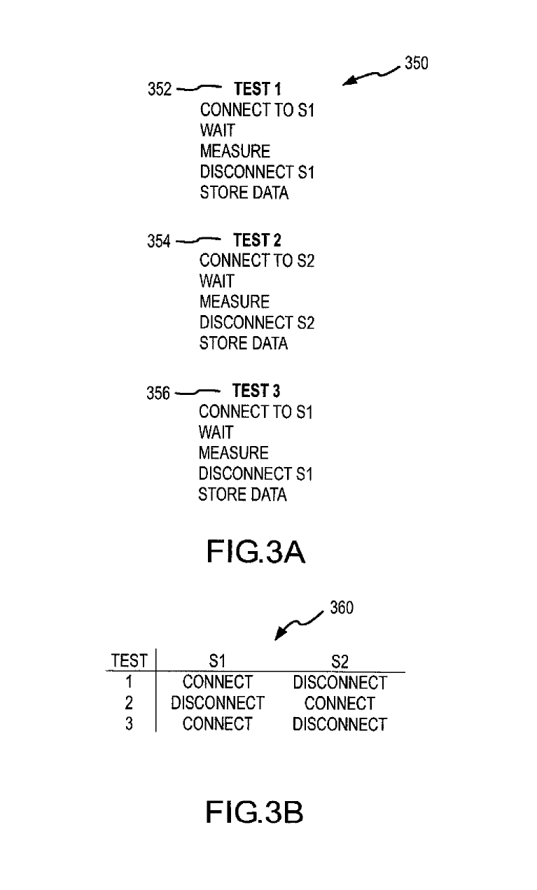

The test program enhancement process 250 may receive an existing test program (step 252), such as an existing production-ready test program, and extract an original test plan from the existing test program. The test program enhancement process 250 suitably scans and/or otherwise analyzes the test program and any other appropriate files and/or executables (step 254) to identify and list major testing steps and actions performed by the test program (step 256). For example, the test program enhancement process 250 may analyze the test program and generate a matrix corresponding to the various tests of the test program and their corresponding operations. Referring to FIGS. 3A-B, a test program 350 may include a first test 352 comprising connecting to a first tester resource SI by closing a relay, waiting for the output signal to stabilize, measuring the output signal, disconnecting the first tester resource S1 from the component 106, and entering the data in a tester data file. Similarly, a second test 354 suitably comprises a connecting to a second tester resource S2 by closing another relay, waiting for the output signal to stabilize, measuring the output signal, disconnecting the second tester resource S2 from the component 106, and entering the data in the tester data file. A third test 356 may comprise a similar process in which the first tester resource S1 is connected to the component 106.

The test program enhancement process 250 suitably identifies the connections to the various sources and enters the appropriate data in a matrix to break down the test plan. Referring to FIG. 3B, in the present embodiment, the test program enhancement process identifies the connections to the voltage sources and completes the matrix 360 for each test 352, 354, 356. The matrix 360 provides a relatively simple representation of certain operations of the test plan. Although the present embodiment uses a matrix 360 corresponding to the voltage connections of the test plan, any appropriate technique or system may be implemented to identify the relevant portions, such as the voltage source connections or other characteristics, of the test plan.

The test program enhancement process 250 suitably analyzes the test plan for potential improvements according to any suitable criteria (FIG. 2, step 258). The test program enhancement process 250 may perform any suitable analyses and provide feedback or modifications. For example, the present embodiment of the test program enhancement process 250 may perform a redundancy reduction process to identify redundancies in the test program and optimize them, for example automatically or by providing recommendations to attending personnel. In the present embodiment, the test program enhancement process 250 analyzes the test plan for redundancies that may be eliminated or rearranged to improve the efficiency of the test program.

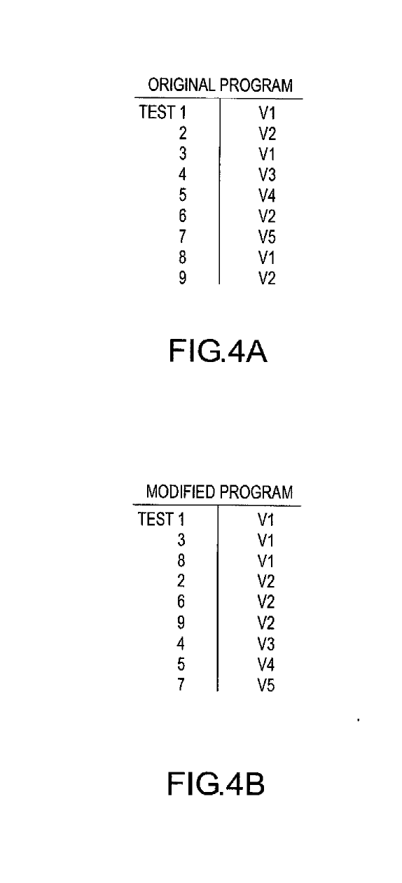

For example, the test program enhancement process 250 may employ a redundancy identifier module to improve the test program efficiency by identifying tests sharing test resources and rearranging the testing sequence to run the relevant tests consecutively. Referring to FIG. 4A, a test plan 450 may call for a first test (T1) using a first applied voltage (V1), followed by a second test (T2) using a second applied voltage (V2), a third test (T3) using the same first applied voltage V1, and so on for a series of tests. Some of the tests use the same voltages as other tests, but intervening tests use different voltages. Consequently, to perform the first and second tests, the test system 100 applies the voltage V1 (for example by closing a first relay connected to a first voltage supply), waits for the output to stabilize, reads the output signal, changes the input voltage to the second voltage V2 (for example by closing a second relay connected to a second voltage supply), waits for the output to stabilize, and reads the second output signal. The process proceeds for each test, including delays between tests for applications of different voltages and waiting for the output to stabilize.

To reduce such delays, the redundancy identifier module suitably identifies tests having common applied voltages and, if appropriate, modifies the test program to perform such tests consecutively. Referring to FIG. 4B, the redundancy identifier module may alter the sequence of the tests such that tests T1, T3, and T8 are performed consecutively. Similarly, tests T2, T6, and T9 are performed consecutively. Thus, all six tests may be performed with only a single change of applied voltage (from V1 to V2) and wait for stabilization.

The test program enhancement process 250 may also perform other suitable analyses to enhance the test program. In the present embodiment, the test program enhancement process may include a test sequence priority module. The test sequence priority module may range the steps of the test program to reduce the overall test time. For example, if certain tests are likely to disqualify a component 106 without further testing, those tests may be performed first. Accordingly, if the component 106 fails to pass these tests, the test program may be terminated for that component 106 and the component 106 may be eliminated from further testing, allowing the test program to move on to the next component 106.

For example, in the present embodiment, a test for the presence of a component 106 may be moved to the initial test, such that if no device is detected, the remaining tests may be disregarded. The next tests may comprise a connection test to determine whether the tester 102 or interface 104 is properly connected to the component 106 and a response test to determine whether any output signal responds to the input signal. Again, if the connection to the component 106 is inadequate or the component 106 does not respond, the component 106 may be designated as defective and the remaining tests may be disregarded. Other tests, such as parametric tests, may be similarly ordered so that, if appropriate, some or all of the remaining tests may be disregarded, thus potentially reducing the duration of the test process for the component 106.

The test program enhancement process 250 may then provide for additional modifications of the test plan (step 260). For example, the test program enhancement process may provide enhancements to the test program, such as upgrading the test program, adding loops to the program, and the like. The test program enhancement process 250 may then provide proposed modifications (step 262), such as by generating feedback and providing suggestions to the attending personnel. In the present embodiment, the test program enhancement process 250 automatically generates proposed modifications of the test plan, such as a revised test sequence based on the redundancy identification module and/or the test sequence priority module. The proposed modifications may be automatically accepted by the test system 100, or may be presented to the attending personnel for adoption or rejection. Alternatively, the test program enhancement process may be configured to provide raw feedback to the attending personnel for conventional review and modification of the test plan. After receiving the feedback and suggestions, the attending personnel may modify the test program based on the feedback. The modified test program may then be prepared for operation (step 264) and verified (step 266) for proper operation.

A test system according to various aspects of the present invention may further generate characterization data. Characterization data suitably comprises a set of test data for components 106 that provide general trends and characteristics of the components 106 under various conditions. For example, characterization data may be generated for the performance of a set of components 106 at various temperatures and operating conditions. For many types of components 106, such as components 106 that operate under non-critical conditions (i.e., toys, appliances, consumer electronics, and the like), the characterization data may be used to reduce the duration of the test process or improve the quality of the testing by facilitating prediction of test results without performing actual tests.

In a test system 100 according to various aspects of the present invention, the characterization data is used to predict the behavior of a component 106 under various possible test conditions, such as at various temperatures based on results obtained at room temperature. Further, the characterization data is suitably used to identify tests that have a relatively low probability of failure. Those tests may then be applied to fewer than all of the tested components 106, thus reducing the overall duration of the test process.

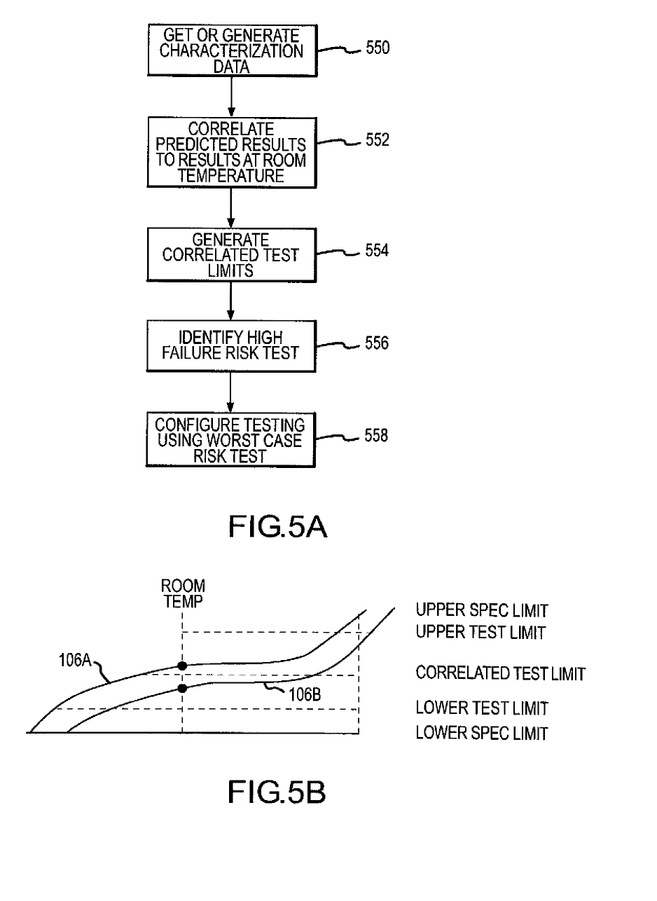

For example, referring to FIG. 5A, the test system 100 initially obtains characterization data (step 550), for example by reading a data file containing test data for a selected number of components 106 that have been tested at all relevant temperature ranges. Alternatively, the test system 100 may generate the test data by testing various components 106 using the relevant tests and temperatures. The test system 100 automatically calculates or reads from the data file statistics based on the data, including characterization data correlating output results at various temperatures to output results at another selected temperature, such as room temperature (step 552). Using the correlated data, the test system 100 may generate correlated test limits for room temperature testing (step 554). For example, a component may pass a test at room temperature, but its predicted output results would exceed the test limit at a selected high temperature. Accordingly, the test system may set correlated test limits for room temperature testing. The correlated test limits define a region of room temperature output results wherein the corresponding predicted results at all other relevant temperatures also pass.

For example, referring to FIG. 5B, first and second components 106A and 106B have different output data curves at different temperatures. At room temperature, the output data for both components 106A, 106B are within the relevant test limits. At a higher temperature T, however, the output data for the first component 106A is outside the test limits, while the output of the second component 106B is within the test limits. Accordingly, the test system 100 may determine a correlated test limit for room temperature testing below the room temperature output data for the first component 106A, but above the room temperature data for the second component 106B.

Using the characterization data, the test system 100 may identify worst case tests for various components 106. In the present embodiment, the test system 100 compares predicted results of the tests at various temperatures to the relevant control limits. The test system 100 uses the comparison results to identify tests having the highest probability of failure, such as tests wherein the predicted output results for the components at the relevant temperatures closest to the test limits (step 556). Because worst case scenario tests are the most likely to approach the test limits, the components may be tested for the worst case scenario tests only at the relevant temperatures, instead of performing tests at all temperatures. For example, if the characterization data indicates that the output results approach the test limit as the temperature increases, the component 106 may be tested only for the highest temperature (step 558).

A test system 100 according to various aspects of the present invention may also determine whether the tester 102 should be calibrated and, if so, alert attending personnel or perform automatic calibration. Calibration of the tester 102 may be required to ensure that the test system 100 applies accurate signals to the components 106 and properly reads the output signals. Unnecessary calibration, however, be induce unwanted variations in the test process, costs, and delays. For example, if the tester 102 is sufficiently calibrated, adjustment of the tester 102 characteristics may induce new and unnecessary variations in the test data. In addition, the overhead time required to calibrate the tester 102 reduces the amount of time available for productive tester 102 operation.

Any suitable system for determining whether calibration is appropriate may be applied. Generally, the test system 100 determines whether calibration is necessary according to test data. For example, the test system 100 may be configured to initiate calibration due to temperature variations or passage of time. Any appropriate criteria may be used to determine whether calibration is necessary, and suitably may be configured by the attending personnel. In the event that calibration is determined to be necessary, the test system may respond in any appropriate manner, for example as predetermined by attending personnel. For example, the test system may be configured to generate an alert, dial a telephone number, send an electronic mail message, or the like. Alternatively, the test system 100 may be configured to automatically calibrate the test system 100.

In addition, the test program may also be adjusted to optimize the efficiency of the test system 100. For example, a test system 100 according to various aspects of the present invention performs a wait period refinement process to refine the duration of the wait period and, in most instances, reduce the overall test time. The test system 100 may analyze the test data and corresponding statistics to monitor whether the process remains under control. At run time, the test system 100 may initially test one or more components 106 to establish a wait period long enough to allow the output signal to stabilize but without wasting substantial additional time. The refined wait period may be automatically implemented or recommended to attending personnel. By determining the preferred wait period, the overall test time for a test run of multiple components 106 may be reduced. In one embodiment of the present test system 100, the test system 100 tends to improve efficiency without substantially increasing risk.

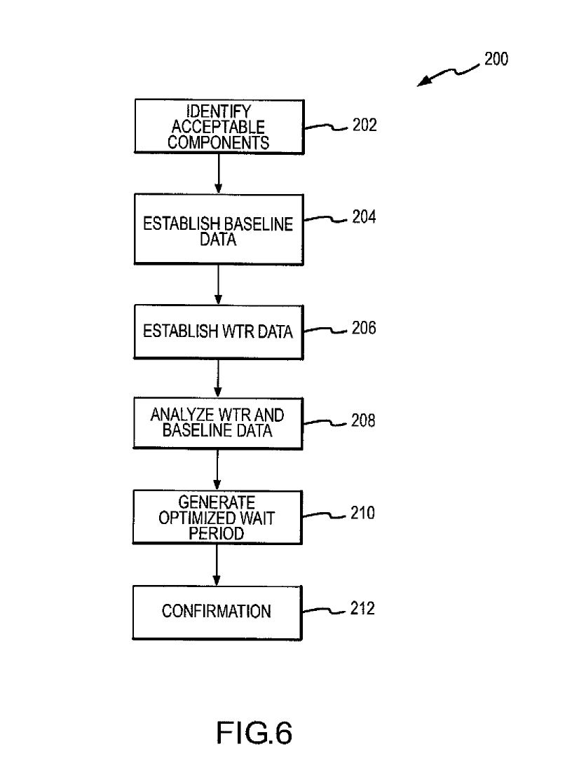

Referring to FIG. 6, in accordance with various aspects of the present invention, the test system 100 performs a wait time refinement process 200 to reduce the overall test time per component 106. Initially, the test system 100 identifies one or more acceptable components 106 (step 202). The acceptable component 106 is tested to establish baseline data (step 204) and wait time reduction (WTR) data (step 206). The baseline data and the WTR data may then be analyzed (step 208), for example in conjunction with a statistical engine, to generate a refined wait period (step 210). The refined wait period may then be verified using one or more other acceptable components 106 (step 212). The wait period refinement process is suitably performed at the time of the test run so that the refined wait period corresponds to the conditions of the test system 100 and the relevant component 106 at run time.

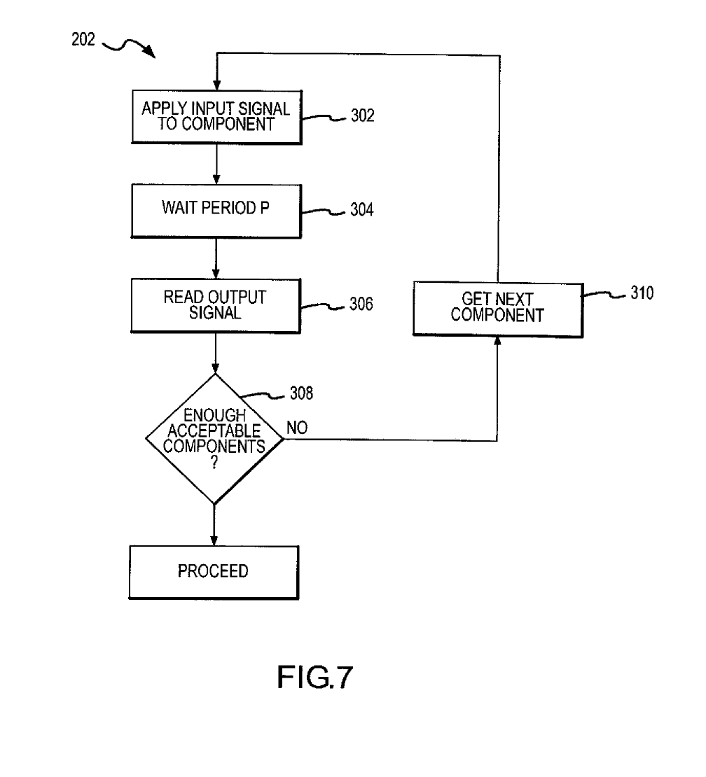

Referring now to FIG. 7, to identify acceptable components 106, the tester 102 begins testing components 106 using an initial wait period P and a testing program. Input signals are applied to the component 106 (step 302), the tester 102 waits the initial wait period P (step 304), and then collects the output test signals from the component 106 (step 306). The initial wait period P is suitably selected, suitably according to conventional criteria, to provide adequate time for the output signal to stabilize prior to collecting the output test signals. The tester 102 continues testing components 106 (step 310) until a desired number of acceptable components 106 are identified (step 308). The number of acceptable components 106 to be identified may be any number satisfactory to confirm validity of the refined wait period, as described below. In addition, the criteria for determining whether a component 106 is acceptable may be selected according to any suitable criteria, such as having zero defects based on a conventional testing analysis. In the present embodiment, the acceptable components 106 comprise any good devices (often referred to as Bin 1 components for any full-specification good device using an initial wait period P). If a component 106 passes all of the relevant tests, the device is GOOD, but if one or more test fails, the component 106 is classified as BAD, or lower quality.

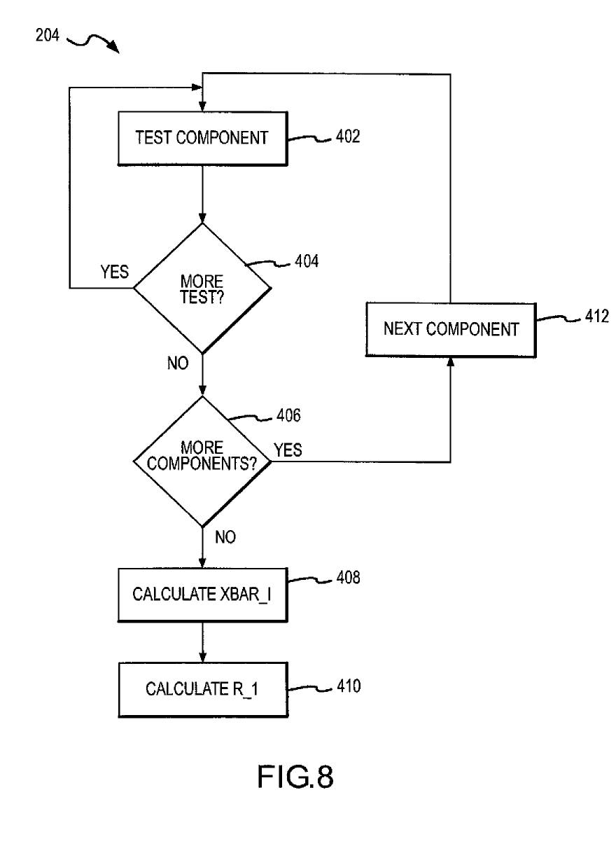

Referring now to FIG. 8, after identifying at least one acceptable component 106, the tester 102 then suitably initiates the baseline test data process 204 to generate baseline output test signal data. The acceptable component 106 is tested one or more times (steps 402, 404), for example ten times in the present embodiment, using the initial wait period P, and the output test signals are collected and stored for each test. The data corresponding to the initial wait period P may then be used to determine a set of baseline data which may then be used to refine the wait period.

For example, the test system 100 suitably implements an XBAR and R statistical analysis in conjunction with the output test signals. In the present embodiment, the test system 100 collects the data for the ten consecutive repeated tests of the same acceptable component 106 and applies a statistical analysis to the output test signal data to establish the baseline data. In particular, the test system 100 establishes a baseline average output signal value (step 408) and a baseline range for the acceptable component 106 (step 410). For example, the data may indicate that the average output test signal for the acceptable components 106 in a particular test using the initial wait period is 4.0 volts (XBAR_I=4.0V), and the range of values for the output test signal is between 3.8 to 4.3 volts (R_I=0.5). Alternatively, the baseline data may be calculated using data from multiple acceptable components 106 (steps 406, 412).

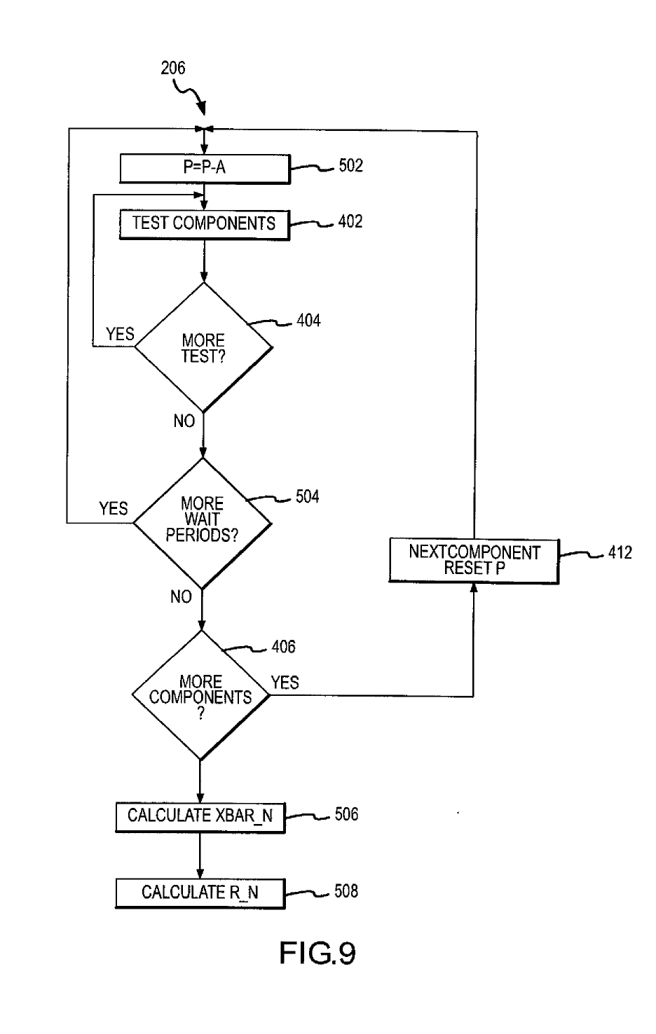

The test system 100 also suitably performs the WTR data process 206 to collect WTR data and identify a refined wait period based on the WTR data and the baseline data. The test system 100 tests one of the acceptable components 106 using different candidate wait periods and collects the corresponding output test signals from the component 106. Referring to FIG. 9, in the present embodiment, the tester 102 repeatedly tests the component 106 using a second wait period for testing (steps 402, 404) that is different than the initial wait period by a selected amount A (step 502). The second wait period may be shorter or longer that the initial wait period according to the objective and implementation of the WTR process. After the output test signal is received, the input signal is again applied to the component 106 using a third wait period that is different than the second period by a selected amount and the output test signal is collected from the component 106.

The process of applying the input signal and collecting the output test signal following decrementally shorter wait periods may be repeated any number of times (step 504). For example, the process may be repeated a set number of times, until the wait periods are shorter than a selected threshold, or until the WTR data, comprising the output test signals and values derived from the output test signals, reach a selected threshold. The test system 100, however, may apply and collect the signals according to any appropriate scheme, such as incrementing wait periods, adjusting the amounts by which the various wait periods differ, and repeating the tests for all or selected wait periods to confirm data. In addition, the test system 100 may repeat this process multiple times on the same component 106, suitably following an interval to stabilize the operating temperature, or apply the process to multiple acceptable components 106 (step 406, 412). In the present embodiment, the WTR data process 206 is repeated five times for each component 106 to establish an array of data points for each candidate wait period.

The WTR data may then be used to establish WTR values for the tester under the particular run-time conditions. In the present embodiment, the WTR data is analyzed using the statistical engine to generate data to be used in the XBAR and R analysis. For example, for each candidate wait period, the test system 100 generates an average output test signal value (XBAR_N) and a range value (R_N) (steps 506, 508).

In the present embodiment, the WTR data is analyzed to identify an optimized wait period based on the baseline data and the WTR data. For example, the test system 100 may calculate a normalized WTR ratio (XBAR) of the difference between the baseline average and the WTR average to the baseline range:
XBAR=(XBAR_{—}N−XBAR_{—}I)/R_{—}I

The test system 100 may also calculate a range ratio (R) of the WTR range to the baseline range:
R=R_{—}N/R_{—}I

The test system 100 suitably identifies an optimized wait period using the XBAR and R values. In the present embodiment, the test system 100 compares the XBAR and R values to selected control limits to identify a candidate wait period for which the process is out of control. For example, suitable control limits for merged data in the present embodiment may be characterized as:
XBAR<+/−0.223
0.348<R<1.652
for initially establishing a refined wait period. These control limits may be adjusted according to the particular process, implementation, and the like. Further, the control limits may be adjusted according to the current objective. For example, wider control limits may be applicable for monitoring an already refined process taking fewer samples in particular, the control limits may selected in accordance with a conventional analysis, such as described in ASTM publication STP-15D, Manual on the Presentation of Data and Control Chart Analysis, 1976.

If the XBAR and R values are within the control limits, the corresponding wait period is designated as ACCEPTABLE, and the process is under control for the corresponding candidate wait period. Conversely, if either the XBAR or the R value is outside the relevant control limits, the process is out of control for the corresponding wait period and is designated as INACCURATE. The test system 100 may analyze the candidate wait periods to identify a longest wait period for which the process is out of control. The test system 100 then suitably uses a longer wait period, such as the next longest candidate wait period, as the refined wait period for analysis of the remaining components 106.

The test system 100 may apply any appropriate analyses of the baseline data and WTR data to establish the optimized wait period, including conventional statistical process control criteria used in an XBAR and R analysis. To reduce errors due to noisy measurements, additional analyses may be applied. For example, if more than a selected number, such as seven, WTR output test signals trend in the same direction, such as continuously decreasing as the wait periods become shorter or longer, then the process is terminated and a particular wait period, such as the initial wait period, is designated as the optimized wait period. In the present embodiment, the third candidate wait period from the beginning of the trend is designated as the optimized wait period.

The WTR data may be analyzed in any manner and at any appropriate time. For example, the WTR data may accumulate and be processed for wait period refinement after testing for a series of candidate wait periods. Alternatively, the data may be processed as it is received for immediate analysis and refinement of the wait period. In the present embodiment, the test system 100 analyzes the output test signal data as it is collected and stops the WTR data process 206 when the refined wait period is identified.

Any suitable criteria may be utilized to identify the refined wait period. For example, the output test signals may be analyzed to identify a threshold wait period for which the output test signals decrease below a threshold. The refined wait period may then be selected based on the threshold wait period, such as by adding a selected duration, typically a few fractions of a second, to the threshold wait period. If no refined wait period can be established, the WTR process may be disabled and testing proceeds using a standard test program, i.e. in conjunction with a conventional wait period, such as the initial wait period. Similarly, if the wait time optimization is not significant, the WTR process likewise may be disabled.

Following identification of the refined wait period, the entire refinement process 200 or the WTR data process may be repeated on further acceptable components 106 one or more times to generate additional wait period data and/or confirm the accuracy of the wait time refinement. Using multiple data points, the refined wait period may be confirmed, for example by averaging the wait period data, selecting the longest or second-longest wait period, or another appropriate analysis.

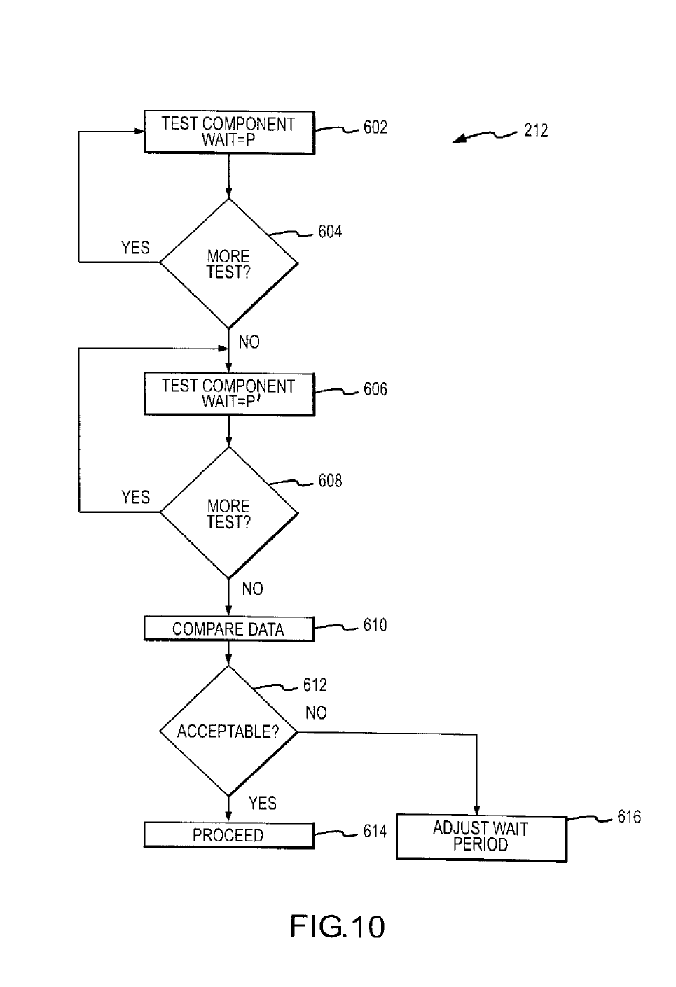

In the present embodiment, the test system 100 uses the confirmation process 212 to verify the accuracy of the refined wait period. For example, referring to FIG. 10, the test system 100 suitably tests at least one of the acceptable components 106 (step 602) a selected number of times (604), such as three, using the initial wait period P. The test system 100 then tests the same component(s) (step 606) a selected number of times (step 608), such as three, using the refined wait period P′. The resulting data from the initial wait period and the refined wait period are then compared (step 610) in any appropriate manner to determine whether the test process is under control using the refined wait period (step 612). For example, the test system 100 may use the XBAR and R process described above. If the resulting values are within pre-selected ranges, the testing proceeds using the refined wait period (step 614). If not, the wait period may be increased, the refinement process 200 may be repeated to calculate a new refined wait period, or the refinement process 200 may be disabled altogether (step 616).

The selected refined wait period may then be applied to testing the remaining components, for example the components 106 of the wafer, lot, test run or the like. The wait period may be refined again according to the present embodiment in conjunction with any suitable criteria, such as the likelihood of variations in the environment, component characteristics, introduction of a new lot of wafers or batch of components 106, test equipment, engineering requirements or production requirements, or any other circumstances that may affect the accuracy of the refined wait period.

Furthermore, other methods may be applied for determining the refined wait period. Any suitable process may be implemented for identifying an appropriate wait time, such as a time that is long enough to allow the output signal to stabilize, but not substantially more. For example, in an alternative embodiment WTR process, the test system 100 utilizes a converging approximation to refine the wait period. In the present alternative embodiment, the test system 100 suitably identifies acceptable components 202 (FIG. 2) and initiates the baseline test data process 204 to generate baseline output test signal data.

The test system 100 performs an alternative wait time refinement process to collect wait refinement data and identify a refined wait period based on the WTR data and the baseline data. Referring to Figure I1, in the present embodiment, the tester 102 repeatedly tests the component 106 using a first wait period P and a second wait period 2P (steps 1110, 1112) that is larger than, for example twice as large as, the duration of the first wait period. After the output test data is received, the relevant statistics are calculated, such as the means for the respective sets of data (step 1114). The statistics for the first period and the second period are then compared (step 1116). If the statistics satisfy selected criteria, then the first and second wait periods are adjusted and the process repeats. For example, if the statistical means for the first period and the second period are substantially equal, then the output signal was stable for both wait periods. Consequently, the first period may be reduced by a selected amount, such as 0.5P, and the second period can be set equal to P (step 1118). On the other hand, if the statistical means for the first period and the second period are substantially different, then the output signal was unstable, and the candidate wait periods should be longer. For example, the second wait period may remain the same, while the first wait period is increased to 1.5P (step 1120).

The duration of the wait time refinement process may be limited in any manner, for example by selecting a number of iterations for the wait time refinement process, continuing until the first or second period is shorter than a selected threshold, or until the WTR data, comprising the output test signals and values derived from the output test signals, reach a selected threshold. In the present embodiment, the process is controlled by an iteration limit, which may be selected according to any appropriate criteria, such as the desired accuracy, magnitude of noise in data measurements, and the duration of each iteration. If the iteration limit has not been reached (step 1122), the components are again tested using the adjusted first and second wait periods. If the iteration limit has been reached, the wait period may be calculated according to the final values for the first and second wait periods.

The test system 100 may calculate the refined wait period to approximate the shortest wait period for which the process is under control (step 1124). For example, the test system 100 may use the final value of the second period as the refined wait period. Following identification of the refined wait period, the entire optimization process 200 or the WTR data process may be repeated on further acceptable components 106 one or more times to generate additional optimized wait period data and/or confirm the accuracy of the wait time optimization.

A test system according to various aspects of the present invention may further be configured to automatically adjust guardbands and test limits for the test system. In the present system, guardbands comprise a selected offset from the specification limits and are defined by the test limits and the specification limits. If a component's output results or relevant statistics exceed the test limits, the component 106 is designated as a failure. Automatic calculation of the guardbands and test limits facilitates proper operation of the test system 100 by compensating for performance variations, for example due to time, drift, humidity, equipment, and the like. Such adjustments may be necessary, for example, due to changes in the operating conditions and/or environment of the test system.

The guardbands may be calculated according to any appropriate technique. The guardbands are suitably large enough to ensure that components 106 that do not meet the relevant specification limits are reliably rejected, but small enough to minimize the number of good devices that are rejected. For example, the guardbands may be calculated according to the reproducibility and repeatability of the test process. In addition, the guardbands may be calculated at any appropriate time, such as according to request of the attendant, at periodic intervals, upon movement of the tester, or after a selected number of test runs.

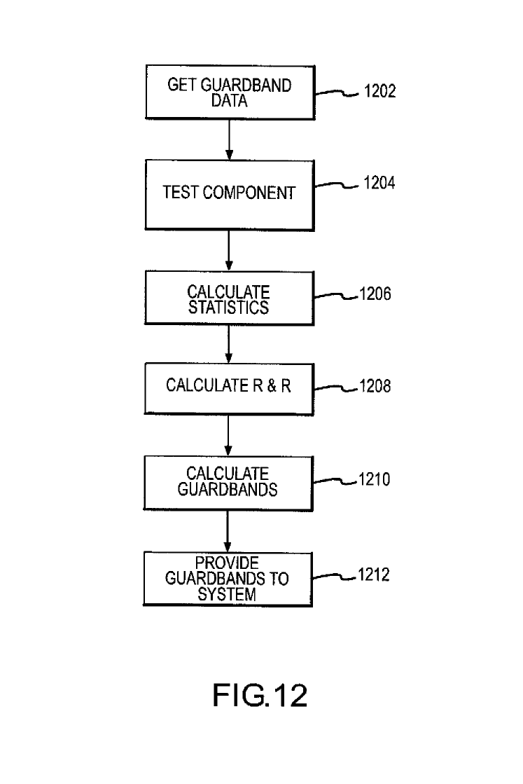

Referring to FIG. 12, in one embodiment, the test system 100 may initially retrieve test information, such as the test program along with various testing parameters like initial guardbands, from a data file (step 1202). The data file may be retrieved from, for example, a central database or from a local memory system. In the present embodiment, the data file is received from a central location so that the test program and the testing parameters may be monitored and modified centrally.

To automatically adjust the guardbands, the test system 100 tests several components 106 (step 1204) and calculates the relevant statistics for the test system 100 (1206). Guardband adjustment may be performed at any appropriate time, for example during the initial run of the test program, upon adjustment of any relevant test parameters, at the request of the attendant, and the like. The test system statistics are used to calculate the repeatability and reproducibility of the test system 100 (step 1208), from which the guardbands may be calculated (step 1210). The automatically calculated guardbands may then be provided to the attendant or automatically implemented (step 1212). Further, the test system may store the calculation data for later analysis, provide a report to the attendant, or otherwise provide information relating to the changes applied to the guardbands. Guardband verification may be performed at any appropriate time, such as when the test system 100 is adjusted for testing new types of components 106. The guardband verification process assists in verifying the proper operation of the test system 100. A result of the process may be provided to attending personnel, such as to provide a notification that the test system 100 is properly operating or to indicate potential problems.

The methods and apparatus according to various aspects of the present invention incorporate statistical process control to provide improved testing at run-time by adjusting the guardbands, improve the wait period between applying input signals and collecting output test signal data, and otherwise enhance the testing process. In one embodiment, the test system uses statistical analysis, such as the XBAR and R analysis, that does not compare the test results to arbitrary or subjective control limits. Instead, the control limits are based on or influenced by the parametric data or the characteristics of the test system 100, such as the presence of noise or the number of samples taken. In addition, the test limits may be refined as well by automatically calculating test limits for the system. Furthermore, other parameters relating to operation of the test system 100, such as frequency (like input signal frequency) and magnitudes (like input signal magnitudes), may also be adjusted to compensate for test system variations.

A test system according to various aspects of the present invention may further operate in conjunction with control samples, such as a control sample comprising multiple components, lots, sublots, or other limited portions of the test run, instead of testing all of the components 106. Using control samples facilitates testing fewer than all of the components 106 in a test run, or applying fewer than all of the tests to the components 106. Because tests or components 106 are sampled instead of fully tested, the test process is shortened. The control samples process may be configured to satisfy any relevant criteria, such as six sigma criteria.

To generate control samples, the test system 100 may generate or retrieve a component history. The component history suitably comprises test results and/or statistics for the type of component 106, and may be retrieved from, for example, a storage location or generated by the test system by testing the components 106. In the present embodiment, the test system 100 suitably retrieves the component history from a central database containing a large component history based on previous tests of like components 106. Alternatively, the component history may be selected or generated in any suitable manner or number. For example, each of a selected number of components 106 may be initially tested using all of the relevant tests to generate a history file for the type of component 106. The size of the history file may be selected according to any suitable criteria, such as reliability requirements of the components 106 or the variations in the data.

In one embodiment of the present test system, the test system reviews the component history to identify highly successful tests, for example characterized by extremely low failure rates, such as a 0% failure rate in ten thousand tests or the like. One or more of the highly successful tests may then be selected for sampling.

All of the tests are then performed on a first group of components 106, such as the components 106 on first wafer. If all of the components 106 pass the selected tests for sampling, the selected tests may be applied to fewer than all of the components 106 in the next group of components 106. For example, the selected tests may be applied to only half of the components 106 on the second wafer. Again, if all of the components 106 pass the selected tests, then the test system 100 applies the selected tests to fewer components 106 in the third group than in the first and second groups. As each group of components 106 is tested, the number of components 106 to which the selected tests are applied is reduced (step 1310) according to any suitable reduction process, for example by reducing the number of components 106 by a percentage. The number of components 106 may continue to be reduced until a minimum number of components 106 are tested.

If a component 106 does not pass one of the selected tests, the test system 100 implements a decision plan (step 1312). The decision plan may be any suitable action or series of actions. For example, the lot may be placed on hold or otherwise marked for retesting or other treatment, according to user-selected criteria. Further, the sampling process may be terminated and reinitiated for following wafers, and the attendant may be notified of the failure to pass the test. The attendant may be presented with a series of options for proceeding, for example according to the type of component 106 and the selected test failed by the component 106.

In implementation of the control sampling process, the test system generates its own component history. For example, all test data may be initially cleared for a lot or batch. All of the tests are run on the components 106 in the first sublot and second sublot, and relevant statistics, such as mean, standard deviation, number of samples, and Cpk are calculated and updated as the components 106 are tested.

The data from the first and second sublots may then be compared to identify significant variations in the data. For example, in the present embodiment, the test system 100 compares the distribution of the data, for example conventional Cpk ratio calculations, for the first and second sublots, though any suitable data may be used. If the data are sufficiently similar, then the data for the two sublots may be merged and testing continues. If not, then the sublots are held and the attending personnel notified.

If testing continues, testing commences on a third sublot, and the relevant data for the third sublot is compared to the merged data of the first and second sublots. If selected data characteristics, in this embodiment the distributions of the data, are statistically similar, then the third sublot data may be merged with the data of the first and second sublots and testing continues. If not, the third sublot is suitably held and the attending personnel notified.

The process of comparing additional sublots to the merged data of prior tested sublots may repeat until an appropriate number of satisfactory components 106 have been tested to establish a control sample. The number of components 106 or sublots required to establish a satisfactory control sample may be selected according to any suitable criteria, such as the necessary reliability of the tested components 106 and/or the extent of variations in the data. For example, the present system tests sublots a selected number of times, such as for three consecutive sublots or more than 2000 components 106, to establish statistical similarity among the sets of data sufficient to generate the control sample.

When the control sample has been established, then the testing process may be streamlined. For example, the test system 100 may compare the data generated for the control sample to any suitable criteria to determine whether to proceed with streamlining the testing process. In the present embodiment, if no failures have occurred among the test data and the Cpk statistics are greater than a threshold, for example 1.5, for the merged data of the control sample, the test system may automatically streamline the testing process.

The test process may be streamlined in any suitable manner. For example, tests which have never failed among any of the components 106 may be run on fewer than all of the components 106 in the next sublot. In the present embodiment, the test system tests a selected fraction of the components 106 with the selected tests. For example, a few of the tests may be eliminated from 9 out of 10 components 106, and all of the tests are executed for the tenth. Any failure causes an alert to be asserted to the attending personnel.

As a greater number of components 106 are tested without detected failures, the fraction of components 106 tested may be further decreased. For example, after testing 5 sublots or more than 5000 components 106, the fraction of the components 106 fully tested may be further reduced, for example to 1 out of 100.

A test system according to various aspects of the present invention may also be configured to automatically retest selected components 106 to confirm or void an initial test determination. For example, a component 106 designated as having failed a test may be retested to determine whether the component 106 was improperly deemed defective. In one embodiment, the component 106 is retested only if the component 106 failed one of a selected set of tests, such as an indication of a missing part or a bad connection, that do not necessarily relate to the quality of the component 106 but instead to the test process itself. If a device retests as an acceptable component 106, the test results for the component 106 may be adjusted, the attendant may be notified, or other appropriate action may be taken.

It should be appreciated that the particular implementations shown and described herein are illustrative of the invention and its best mode and are not intended to otherwise limit the scope of the present invention in any way. Indeed, for the sake of brevity, conventional signal processing, data transmission, and other functional aspects of the systems (and components 106 of the individual operating components 106 of the systems) may not be described in detail herein. Furthermore, the connecting lines shown in the various figures contained herein are intended to represent exemplary functional relationships and/or physical couplings between the various elements. Many alternative or additional functional relationships or physical connections may be present in a practical test system.

The present invention has been described above with reference to a preferred embodiment. However, changes and modifications may be made to the preferred embodiment without departing from the scope of the present invention. These and other changes or modifications are intended to be included within the scope of the present invention, as expressed in the following claims.

1. A computer system for controlling a tester testing components using a plurality of tests, comprising:
a storage system for storing a history of test results for the plurality of tests; and
a control system configured to automatically adjust a guardband using the history of test results and cause the tester to apply the adjusted guardband for testing the components.

2. A computer system according to claim 1, wherein the history of test results is generated testing an initial set of components.

3. A computer system according to claim 1, wherein the storage system comprises a central set of data configured to store a plurality of histories of test results for a plurality of testers.

4. A computer system according to claim 1, wherein the control system is configured to automatically adjust the guardband based on at least one of a reproducibility and a repeatability of a test.

5. A method of controlling the operation of a tester, comprising:
testing a first set of components to generate a set of test results;
automatically calculating an adjusted guardband based on the test results; and
adjusting a guardband used by the tester according to the adjusted guardband.

6. A method of controlling the operation of a tester according to claim 5, further comprising storing location accessible by multiple testers.

7. A method of controlling the operation of a tester according to claim 6, further comprising retrieving the stored data from the central location.

8. A method of controlling the operation of a tester according to claim 5, wherein automatically adjusting the guardband comprises adjusting the guardband based on at least one of a reproducibility and a repeatability of a test.
